(19) United States
(12) Patent Application Publication
(10) Pub. No.: US 2013/0041879 A1
(43) Pub. Date: Feb. 14, 2013

(54) INTEGRAL SEARCH ENGINE

(71) Applicant: George Moser, Redwood City, CA (US)

(72) Inventor: George Moser, Redwood City, CA (US)

(21) Appl. No.: 13/351,178

(22) Filed: Jan. 16, 2012

Related U.S. Application Data
(60) Provisional application No. 61/574,703, filed on Aug. 8, 2011.

(51) Int. Cl. G06F 17/30

(52) U.S. Cl. 707/706; 707/E17.108

(57) ABSTRACT

An Internet search engine is provided, having integrated software tools enabling users to post-process search results for extraction of content. Processing and formatting required to utilize content in different applications is automated.

### FIELD OF THE INVENTION

The present invention is in the computer software field, with focus on an improved search engine for Internet searching.

### BACKGROUND

Search engines for Internet searching, such as Google, Yahoo and others, have made an enormous wealth of information available to computer users and have made and continue to make a huge contribution to science, education, culture, business and general dissemination of human knowledge. Search engines have been designed with a high degree of user-friendliness, putting great knowledge and information resources at the fingertips of the population regardless of their level of computer skills. Users of search engines include all segments of the population, from highly sophisticated users with advanced computer expertise to millions of users with very limited familiarity with computers and software.

However, one area with substantial room for improvement is the utilization of the information once found. Current search engines typically find the information, display it on the screen for the user and then leave the user on his/her own regarding what to do with the information found. While sophisticated users can further process the information found with a manageable degree of difficulty due to their high computer skill level, average and lower-skilled users can have great difficulty in utilizing the information efficiently. There is a need for a more user-friendly next generation search engine that will support the user beyond just displaying lists of hits, enabling the user to efficiently process the information displayed on the screen. The next generation search engine should not be focused purely on finding hits, but also on providing efficient and user-friendly ways to process the information found.

### BRIEF DESCRIPTION OF THE DRAWINGS

FIG. 1 is an illustration of a prior art search engine user interface.

FIG. 2 is an illustration of another prior art search engine user interface.

FIG. 3 is an illustration of a further aspect of a prior art search engine user interface.

FIG. 4 is an illustration of a further aspect of a prior art search engine user interface.

FIG. 5A is a flowchart of a prior art process for using a search engine.

FIG. 5B is a flowchart of a prior art process for using a search engine.

FIG. 6 is a flowchart of a process for using a search engine, in accordance with an exemplary embodiment described herein.

FIG. 7 is a flowchart of a further aspect of a process for using a search engine.

FIG. 8 is an illustration of a search engine user interface.

FIG. 9 is an illustration of a further aspect of a search engine user interface.

FIG. 10 is an illustration of a further aspect of a search engine user interface.

FIG. 11 is a flowchart of a further aspect of a process for using a search engine.

FIG. 12 is an illustration of a further aspect of a search engine user interface.

FIG. 13 is an illustration of a further aspect of a search engine user interface.

### DETAILED DESCRIPTION

While this invention is susceptible to embodiment in many different forms, there are described in detail herein several specific embodiments, with the understanding that the present disclosure is to be considered as an exemplification of the principles of the invention and is not intended to limit the invention to the embodiments illustrated.

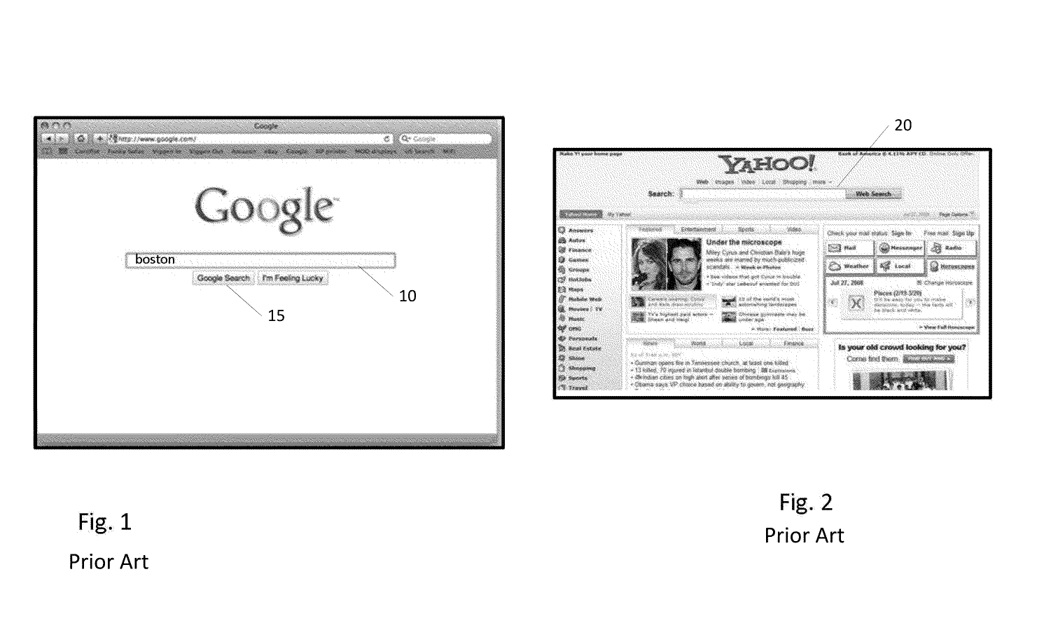

FIG. 1 shows the well-known main page of a leading current search engine, Google. A very distinctive feature is the simple, clean and uncluttered nature of the main page, which keeps the user focused on his/her search without distractions. Another key feature is the search box 10, where the user enters the search target. This is kept very easy and simple: by default all the user has to do is to enter some text into the search box (as an example, in FIG. 1 the user entered the word “boston” to look for information about the city of Boston) and then click on “Google Search” button 15 to conduct the search. This way any user can quickly and easily use the search engine. It's a very user-friendly approach, and the only required skills is basically to know how to type.

FIG. 2 shows the main page of the Yahoo search engine, which has a similar search box 20. Almost all current search engines use the same approach, providing a search entry box where the user can easily enter the search target.

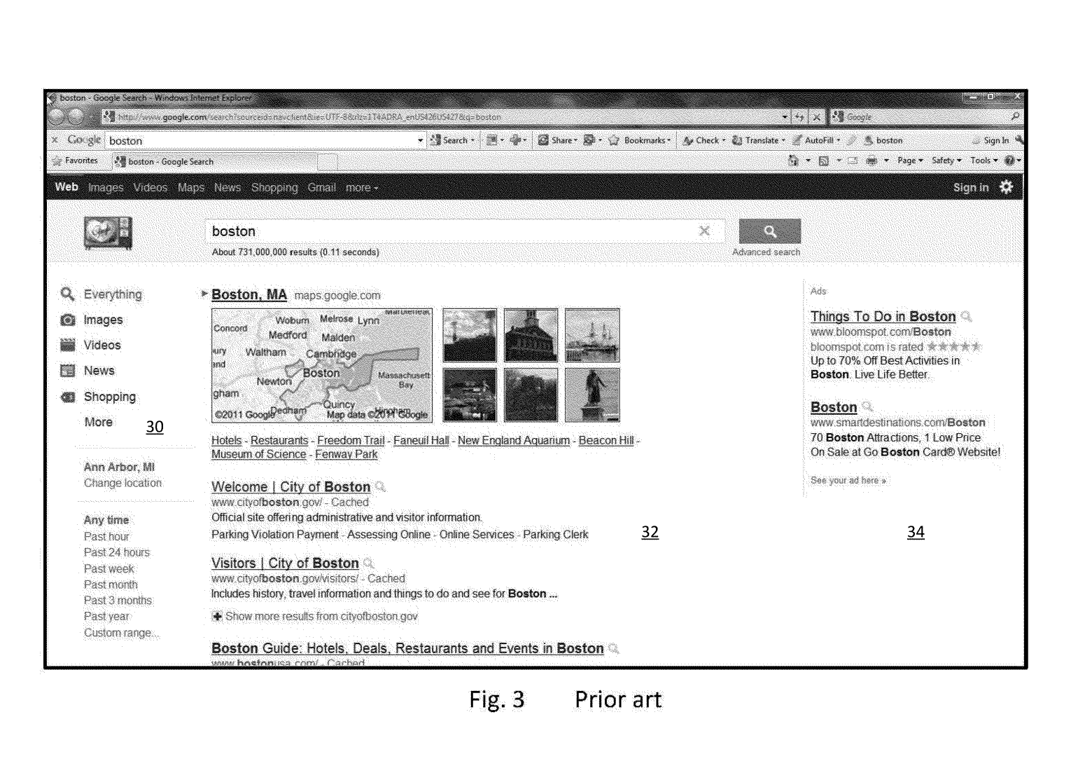

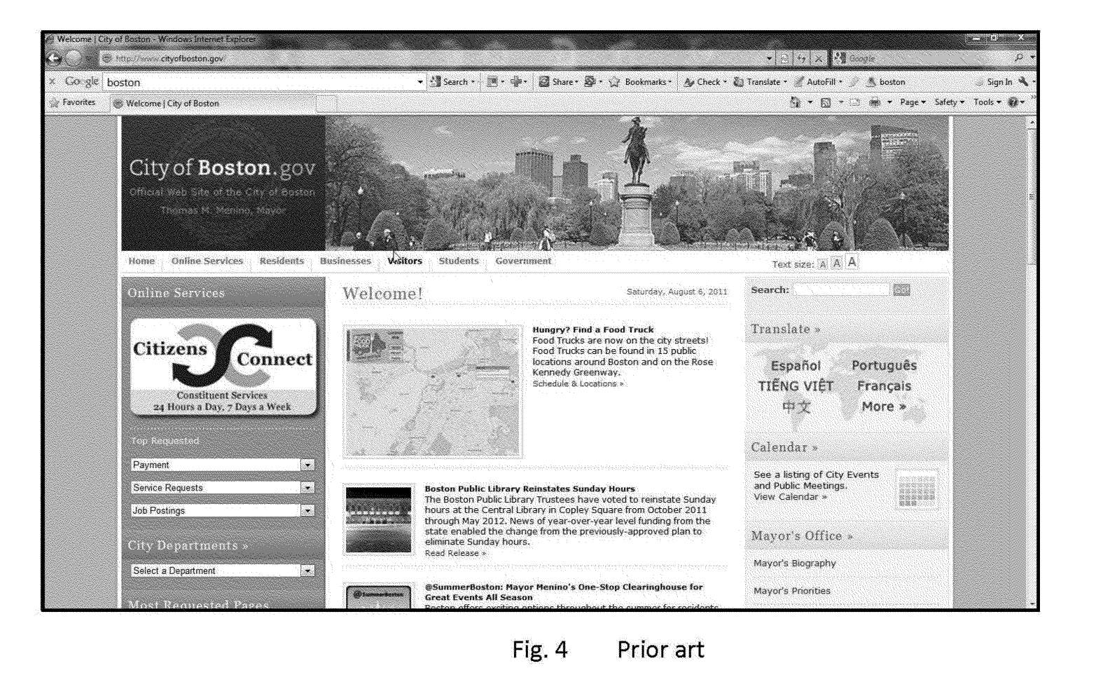

In FIG. 3, the results of the search for “Boston” using the prior art Google search engine are shown. Other conventional search engines may yield results in a comparable format. The results page is split in 3 vertical areas: a) the left area 30 contains some buttons that the user can click to focus or modify the search (for instance, focus on Images, Videos or another category); b) the main area 32 in the center displays the search results; and c) the right area 34 is used for advertising. This is a good structure to visualize results, but it doesn't necessarily provide maximum assistance to the user in processing the information found. Looking again at FIG. 3, let's assume the user selects the first search result (the one labeled “Welcome—City of Boston”) and clicks on it. The result is illustrated in FIG. 4.

FIG. 4 shows a typical information page obtained through a search engine. At this point the search engine basically considers its job done and leaves the user alone. The user often may want to use the information displayed in the screen for some purpose (for instance, to create a text document, to extract portions of it to merge them into a brochure, to save it as an editable document for future use, to extract images, etc.). However, the search engine does not provide further help in achieving those tasks, which for experienced computer users can be frustrating, and daunting and very time consuming for the non-expert user.

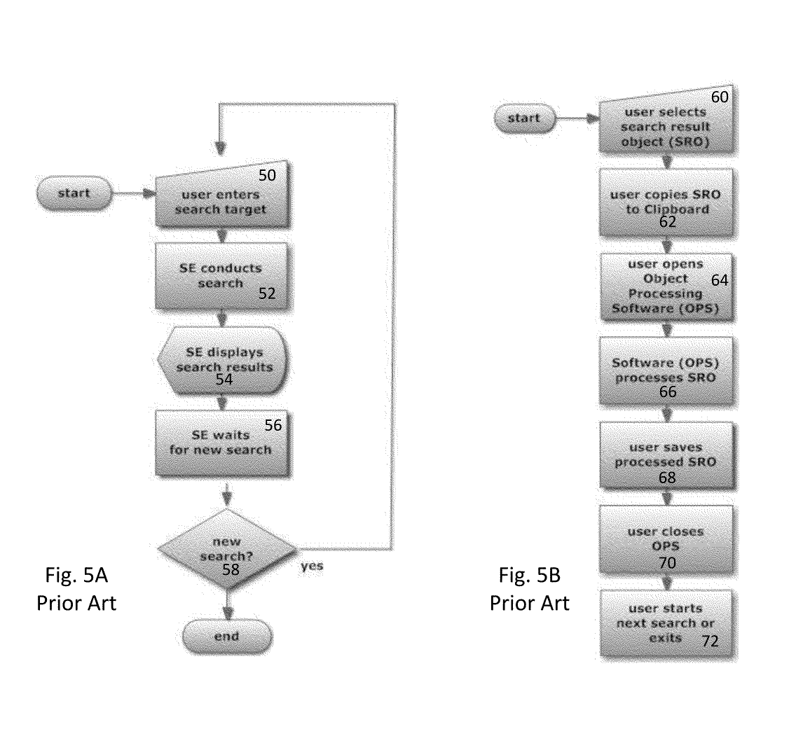

FIG. 5A is a flowchart of a process by which typical search engines are currently utilized. The user starts the search engine, and then enters a search string into the search box (step 50). That triggers a search by the search engine (abbreviated SE) in step 52. When the search is completed, the SE displays the search results on the screen, step 54. After that the SE considers that it has done its mission, and just waits for another search (step 56). The user may not be done though. Actually for many users now the real task begins: extracting useful portions of the found information or converting the found information into something usable within a document, report, brochure, email or other object. Therefore now the user has to start a parallel process, shown in FIG. 5B, once the user has selected one of the search results and viewed it on the screen. Now, for example let's assume the user found a portion of the displayed search result to be of interest and decides to extract it. The most common method is to select portion of the displayed search result object (SRO) (step 60) and then copy it into the Clipboard (step 62). This method works sometimes and sometimes it doesn't, depending on the SRO (an SRO may be a website or page thereof, a Wikipedia article, an html file, a pdf file, a text file, a newspaper article, an image, a chart, a newspaper article, a movie, a video, a song, or any other type of material that can be found by a search engine on the Internet).

In step 64, the user will then typically open a separate Object Processing Software (OPS) package (such as for instance a word processor like Microsoft Word), and paste the contents of the Clipboard into the word processor to edit it. Often significant difficulty is experienced in doing that, especially because the SRO typically contains graphics and images that are difficult to avoid during the copy process, and end up disturbing the formatting of the word processor document.

The object processing software (OPS) used by the user to process the selected search result object (SRO) can be a word processor (such as Word, Pages or Writer), a spreadsheet program (such as Excel, Numbers or Calc), a presentation program (such as Powerpoint, Keynote or Impress), a database program (such as Excel or Calc), a publishing program for text and images (such as Publisher), an image processor (such as Photoshop), a screen capture program, a drawing program, an audio editor/processor, a video editor/processor and/or other programs that can be used to process an SRO.

After using an OPS to process the found SRO (step 66), the user saves the results of his/her work as a processed object (step 68), and then closes the OPS (step 70). The above described process is often unsuccessful, because of incompatibilities between the SRO and the OPS. Even when successful, this process can require a large amount of time to overcome the incompatibilities. Typically the user will go back to the search engine and conduct a new search to try to find results that are more compatible and easier to process (step 72).

In summary the current methodology consists of separate processes: the search process (e.g. that of FIG. 5A) and the editing process (e.g. that of FIG. 5B). The search engine does a very good job with the search process, but provides no help with the second step, the subsequent additional processing and editing of the found results.

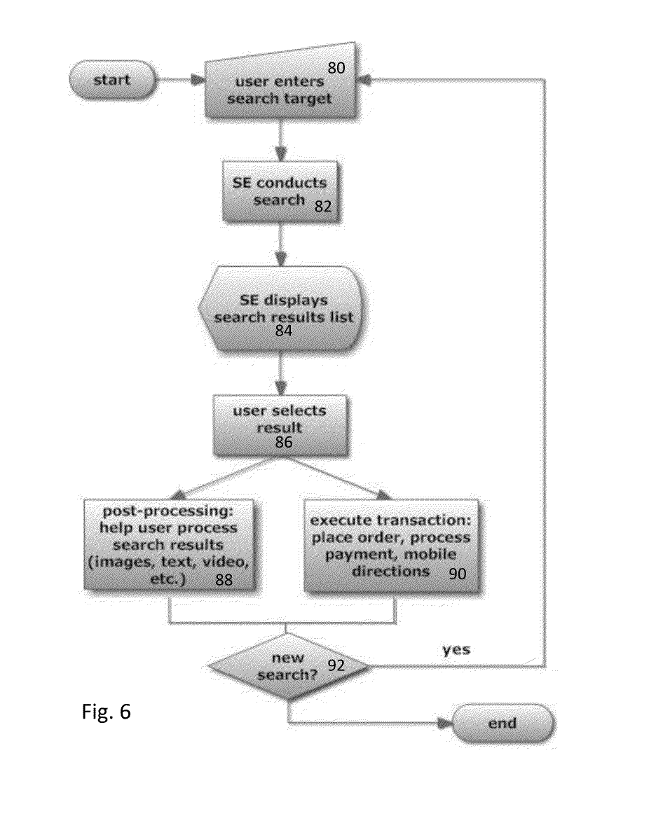

FIG. 6 illustrates a new process for utilizing a search engine, which is based on a different approach and different logic: the first step is the entering of a search target by the user (step 80). The search engine conducts the search (step 82) and displays a list of the results found (the “hit list”) (step 84). The user then selects a result from the list that is of interest to him/her (step 86). At this point, the user has basically two options: a) request assistance from the search engine for post-processing the search result (step 88), for instance to extract some graphics from the results and edit it, or b) if the search is for a product or service that can be purchased, rented or otherwise acquired, the user can actually execute such transaction (step 90), using different built-in software modules of the search engine that allow it to provide more information, place an order for the product, process payment, provide directions on the computer or on a mobile device or otherwise facilitate the actual execution of the transaction.

Both branches of the software logic diagram of FIG. 6 (i.e. step 88 and step 90) are important, because the left branch (post-processing of results) represents good service to the users and can greatly contribute to attract users to the search engine, while the right-hand branch (execution of transactions) has a very high revenue potential by charging a small transaction fee for facilitating and executing the transaction. Once a search result is utilized, the user can decide whether to execute another search (step 92).

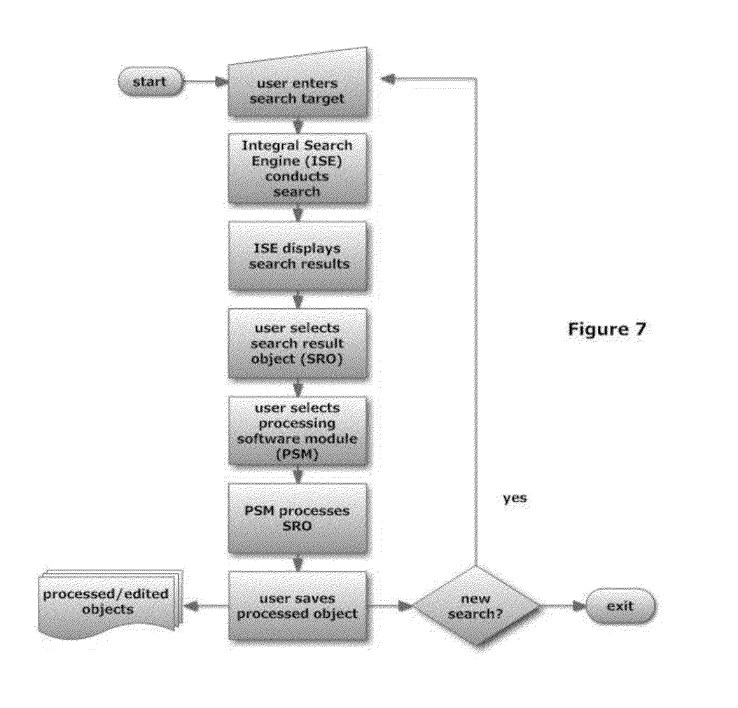

FIG. 7 shows the post-processing branch of the software diagram in more detail: instead of two or more separate processes (as previously shown in FIG. 5), the search and post-processing processes are merged into just one seamless process, providing an unprecedented level of user-friendliness, efficiency and convenience to the user. The new Integral Search Engine contains the tools and features that make this possible. Post-processing is defined as all the steps, work processes, manipulations, conversions, extractions, editing, alterations and sub-processes necessary after the search to turn the search result objects into edited objects that match the needs of the user for the intended purposes. An example would be to select a subset from a document found in a search to create a piece of compatible, well-edited text including fitting, well-formatted images, said piece to be integrated into the body of a brochure that the user is creating. Post-processing refers to all the steps necessary to create such piece out of a search result. Post-processing is currently done outside, independently and without support from the search engine. The integrated search engine of this invention provides the tools to do the post-processing from within the integral search engine.

As shown in FIG. 7, the user starts the Integral Search Engine (ISE) and enters a search target. The ISE conducts the search and then displays the results list on the screen. The user selects the desired search result object (the SRO, of more commonly called the hit) he/she is interested in. The user inspects the selected SRO and finds the relevant portions. Then the user chooses a Processing Software Module (PSM), from within the Integral Search Engine, to process/edit the selected SRO. The choice of PSM will depend on the nature of the SRO and on what the user wants to do with it. For instance, to extract text from an SRO and insert it into a text document, the typical SPM of choice could be a word processor. To extract text, images and graphics the typical SPM could be a publishing software package. For other objects, a video or audio SPM may be the right choice, etc.

The PSM may be external to the ISE (such as a call to an external 3rd party software like Microsoft Word) or internal to the ISE (i.e. the ISE may have its own word processor, as an integral part of its own code or as a subroutine attached to it which the main program can call as needed). In either case the processing should be totally or at least partially transparent to the user.

After the PSM processes/edits the SRO, the processed object is saved by the user in a format chosen from a list of possible formats offered by the PSM to the user. After saving the processed objects, the user may decide to do another search or exit.

The above described methodology can be implemented in many different ways, all within the scope and purposes of this invention.

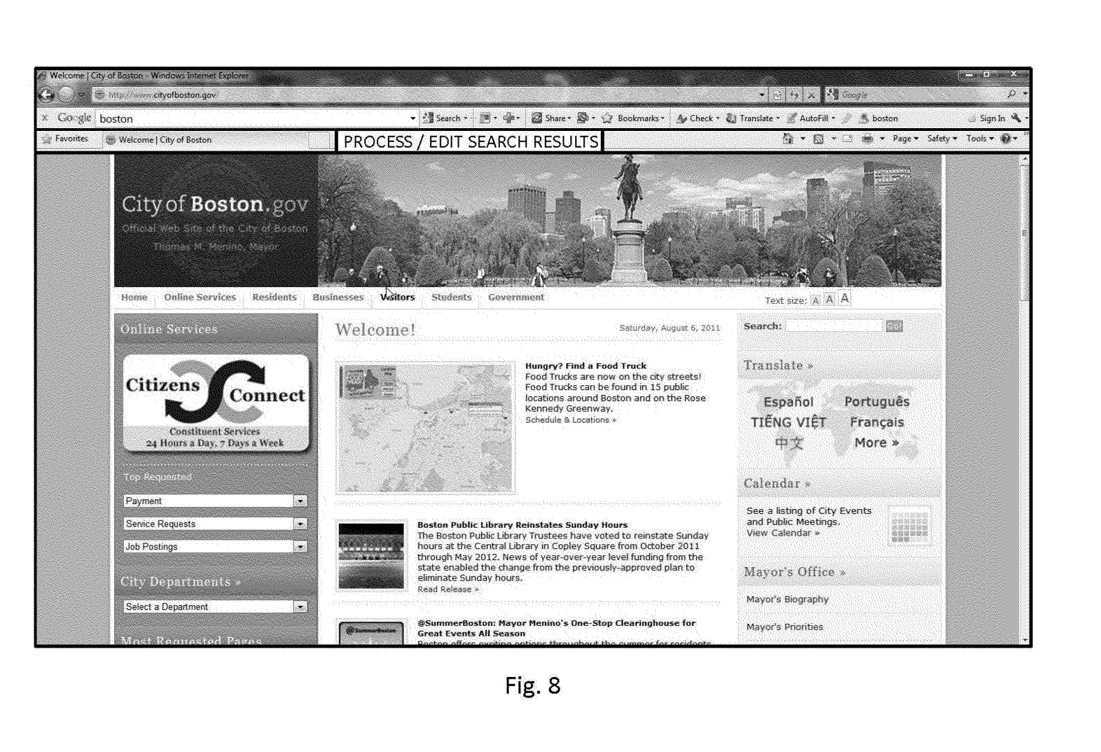

FIG. 8 shows one of the many possible implementations of the invention. The results page shown in FIG. 8 incorporates a new button labeled “PROCESS/EDIT SEARCH RESULTS”, which the user can click at any time to process the search results displayed on the screen.

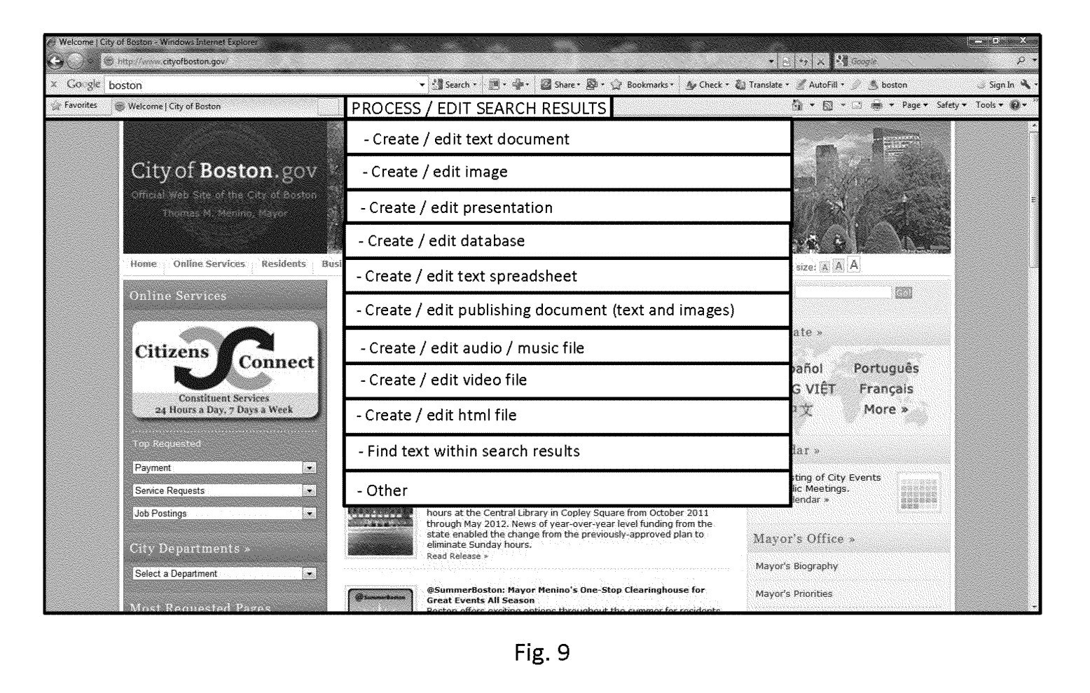

FIG. 9 shows a drop-down menu displayed by the ISE when the user clicks on the “PROCESS/EDIT SEARCH RESULTS”. Several different options are offered, such as creating/editing a text document, an image, a publishing document, a spreadsheet, a presentation, etc.

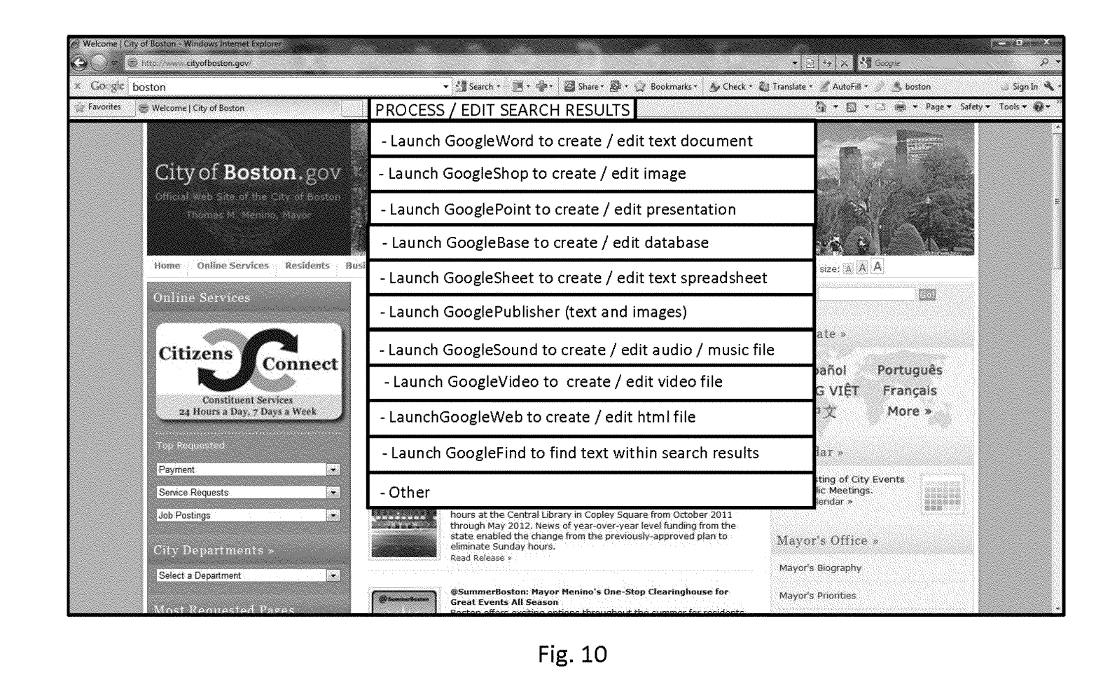

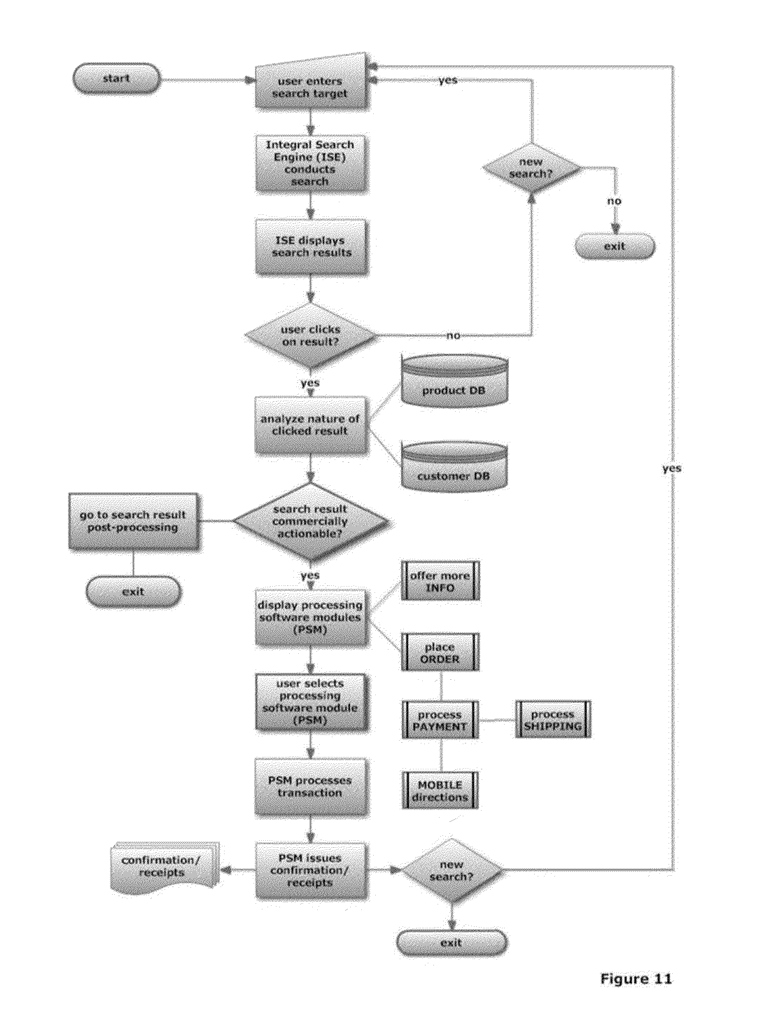

FIG. 10 shows a different version of the drop-down menu of FIG. 9, wherein the choices are based on triggering a specific software module, which may be integral to the Search Engine, such as for example the software modules shown in FIG. 9 with the assumed names GoogleWord, GoogleShop, GooglePoint, etc.

A major advantage of the Processing Software Modules (post-processing software) embedded in the Integral Search Engine is the efficiency and convenience for the user by using software that has been tested to work and ensured compatible with the search results of the search engine. The seamless and compatible processing of results can provide a major improvement in user experience. Simultaneously, this approach offers major commercial advantages to the owner of the search engine, by providing the opportunity to quickly popularize software such as word processing, spreadsheet and presentation software and others using the context of a search engine and capture a substantial market share of that large software market, especially if the search engine makes those software applications available and easily accessible with or without a search.

FIG. 11 describes in detail the second branch (the right-hand side branch) of FIG. 6, which is the one that executes transactions when the product or service lends itself to such a process. The steps involved are as follows:
the user enters the search target (the “search term”) and the Integral Search Engine conducts the search, generating a hit list which is displayed on the screen.
the user selects a result from the list by clicking on it.
the ISE analyzes the nature of the search result to determine if the search result object is a product or service that can be purchased (“commercially actionable”) by the user. This analysis is based on data in a product data base and in a customer database.

If the product or service selected by the user is commercially actionable, the user can use different software modules to actually perform the transaction: the INFO module can provide additional information that can help the user decide whether to pursue the transaction or not; the ORDER module can be used to actually place an order for the desired product or service; the PAYMENT, SHIPPING and MOBILE DIRECTIONS modules execute the transaction and support it from a logistical point of view.

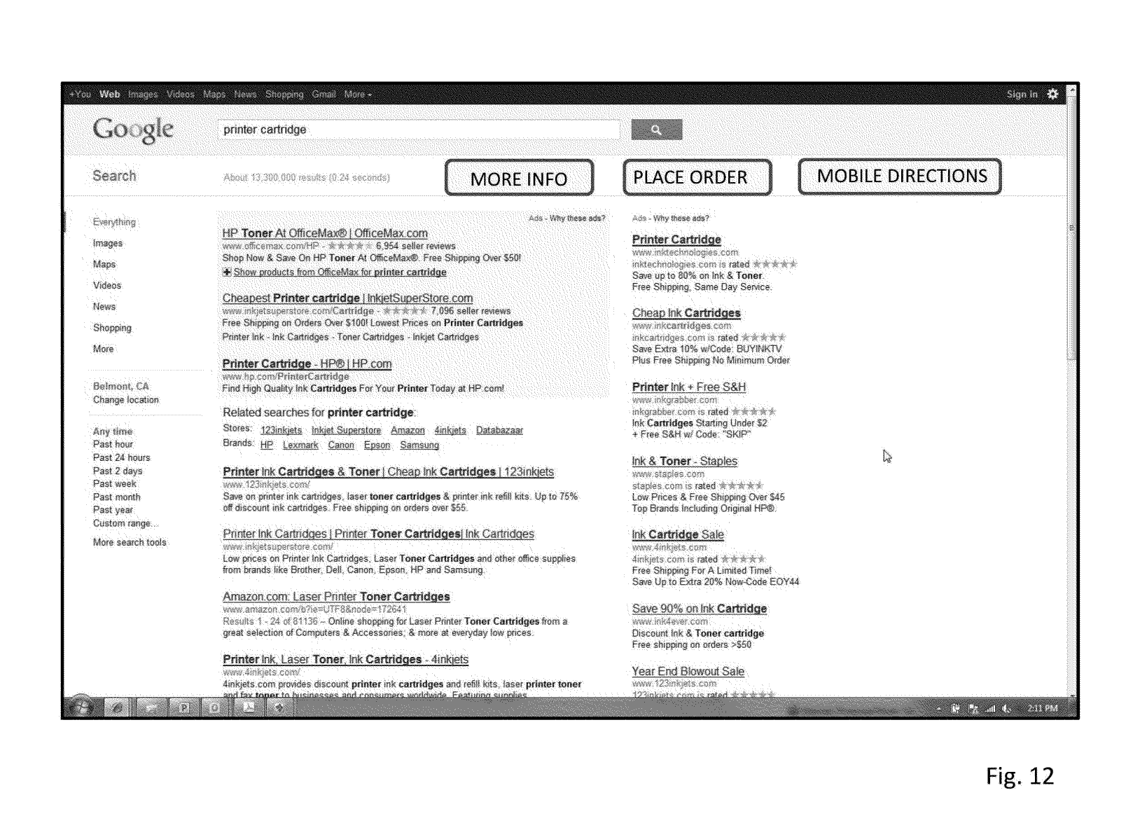

FIG. 12 is an example of a results page for the search term “printer cartridge”. Numerous results are displayed. The search engine also prominently displays additional valuable resources for the user, such as the integral software modules MORE INFO, PLACE ORDER and MOBILE DIRECTIONS. These features allow the user to complete his/her shopping (shopping is a search) and place an order right there. When those software modules are selected, they trigger other menus that support the payment and the logistics of the transaction. These new capabilities offer the maximum efficiency and convenience to the user, as well as the highest revenue potential to the Search Engine.

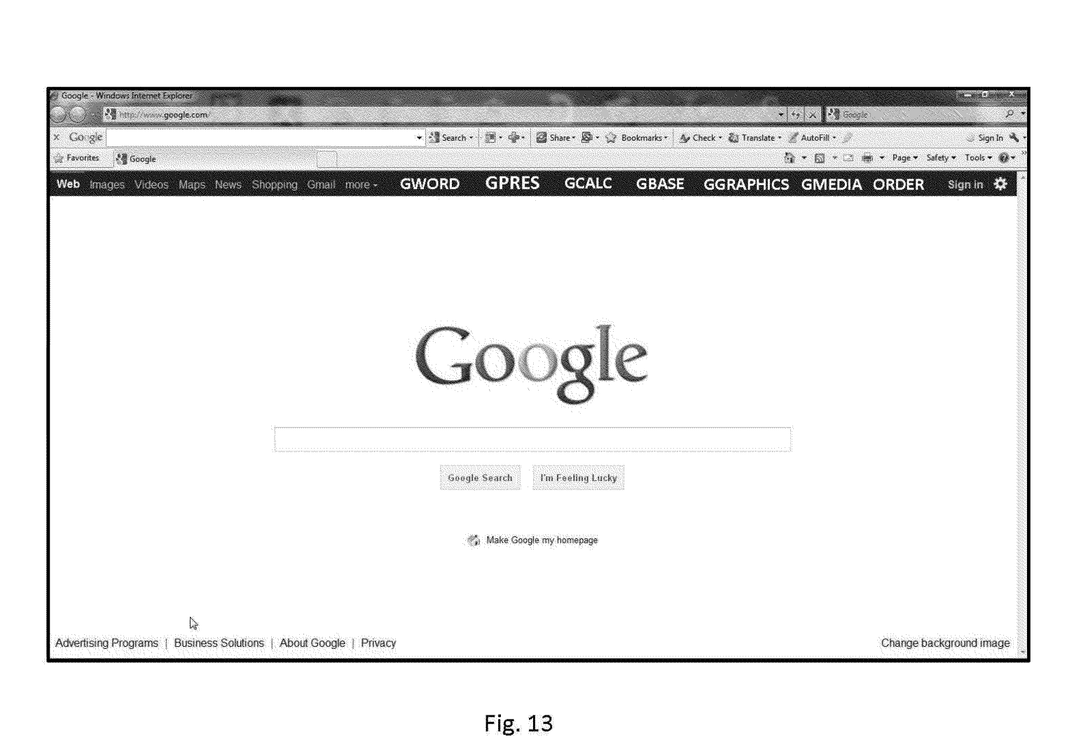

FIG. 13 shows a modified main page for the Integral Search Engine that illustrates what the future face of an integral search engine could look like, with integrated software modules such as GWORD (word processing), GCALC (spreadsheets), GPRES (presentations), GCALC (calculations/spreadsheets), GBASE (database), GGRAPHICS (image processing), GMEDIA (audio, video and other media) and ORDER (transaction execution, including payment and logistics). The ISE provides not only searches but a comprehensive set of software tools, such as a complete office suite and others, which could all be used within the context of a search to process search results, but also could be used on a stand-alone basis (not necessarily within the context of a search) if the user so desires. Another powerful tool (not shown) that could be added would be email client software (equivalent to Microsoft Outlook), which could also be used within the context of a search or in stand-alone mode. Also, from a transactional point of view, it makes sense to allow the user to complete the purchase transaction immediately to maximize efficiency, convenience and also sales opportunity.

The trade names Google, Yahoo or any others in this document are used in this document as examples and for better understanding of the invention only. The invention is not limited to or specific to those search engines.

The foregoing description and drawings merely explain and illustrate the invention and the invention is not limited thereto except insofar as the appended claims are so limited, as those skilled in the art who have the disclosure before them will be able to make modifications and variations therein without departing from the scope of the invention.

What is claimed:

1. A search engine with integrated software tools that allow the user to post-process the results of a search conducted by the search engine from within the search engine using integrated software modules.

2. The search engine of claim 1 wherein the integrated software modules allow the user to relatively easily extract the content of a search result object (SRO), or a user-specifiable subset thereof, and then create a user-specifiable file with said content, or merge it into a user-specifiable file.

3. The search engine of claim 2 wherein the file is editable or modifiable with the integrated software tools provided by the search engine.

4. The search engine of claim 2 wherein the file is a text file that can be processed with a text editor integrated with the search engine.

5. The search engine of claim 2 wherein the file is a publishing file containing text and images, which can be processed with a publishing program integrated with the search engine.

6. The search engine of claim 2 wherein the file is a spreadsheet file that can be processed with a spreadsheet program integrated with the search engine.

7. The search engine of claim 2 wherein the file is a database file that can be processed with a data base program integrated with the search engine.

8. The search engine of claim 2 wherein the file is a presentation file that can be processed with a presentation program/slide editor integrated with the search engine.

9. The search engine of claim 2 wherein the file is a graphics file that can be processed with a graphics package integrated with the search engine.

10. The search engine of claim 2 wherein the file is a media file, such as audio or video, that can be processed with an audio editing/processing software package integrated with the search engine.

11. The search engine of claim 2 wherein the file is an html file that can be processed with an html editing/programming software package integrated with the search engine.

12. The search engine of claim 2 wherein the file is a screen capture file that can be processed with a screen capture software package integrated with the search engine.

13. The search engine of claim 2 wherein the file is a file of any of the formats that can be found with a search engine, which can be processed with a compatible software package or software module integrated with the search engine.

14. The search engine of claim 1 wherein the integrated software tools allow the user to process/edit the search result object directly on the screen and subsequently save it as a user-specifiable file.

15. The search engine of claim 1 wherein the integrated software tools allow the user to easily find a particular word, string or other object within the search result.

16. The search engine of claim 1 wherein the integrated software tools allow the user to easily mark, highlight or annotate the information found by the search engine.

17. The search engine of claim 1 wherein the integrated software tools allow the user to easily display next to each search hit other relevant information, if available, such as date/age of the information, visitor statistics, copyright information and other criteria relevant to the user.

18. The search engine of claim 1 wherein the integrated software tools allow the user to easily sort or re-sort the hit list according to user-specifiable criteria.

19. The search engine of claim 1 wherein the integrated software tools allow the user to easily save or print portions of the information found by the search engine.

20. The search engine of claim 1 wherein the search engine provides copyright guidance to the user on demand or by default.

21. The search engine of claim 1 wherein the list of integrated software tools can be invoked by the user at any time with a right click, a certain function key or a certain keystroke combination.

22. The search engine of claim 1 wherein the integrated software tools consist basically of software code either integral with the search engine code or in form of subroutines, procedures, processes or subprocesses attached to the search engine main program which can be called and triggered by the main program as needed (this is also called the “internal integration approach”).

23. The search engine of claim 1 wherein the integrated software tools are basically external software packages, typically third party packages, which may be installed on the user's computer or on the cloud, and for which the search engine has links that allow the search engine to automatically call them and trigger them when the user requests a function that requires them (this is also called the “external integration approach”).

24. The search engine of claim 1 wherein the integrated software tools include internal integral code as well as external software packages (this is also called the “mixed integration approach”).

25. A search engine with integrated software tools that allow the user to use said tools to either a) post-process the results of a search conducted by the search engine from within the search engine, or b) use said tools in a stand-alone mode, not necessarily within the context of an Internet search.

26. The search engine of claim 26 wherein the integrated software modules include one or more of the following software tools: text editing, word processing, spreadsheet, presentation, database, publishing, graphics editing/processing, audio editing/processing, video editing/processing, html editing/programming, email client software (such as Outlook), screen capture or any other relevant tools.

27. The search engine of claim 26 wherein the integrated software tools may reside in the user's computer, inside the search engine software or in the cloud.

28. An integral search engine with integrated software modules that allow the user to a) conduct a search for a product or service that can be purchased, rented, leased or otherwise acquired by the user and then b) select a result from the search results list and actually execute the purchase/acquisition process from within the search engine.

29. The integral search engine of claim 28 wherein the integral search engine includes software modules that at least one of the following functions for the user: provide additional information and decision support services; enable the user to place the order; enable to user to make payment online; support the user with the logistics of the transaction, such as shipping arrangements, pickup directions on the computer and/or a mobile device, and other transaction support.

30. The integral search engine of claim 1 that can also provide the transactional capabilities of claims 28 and 29.
